(19) United States
(12) Patent Application Publication
(10) Pub. No.: US 2025/0084749 A1
(43) Pub. Date: Mar. 13, 2025

(54) ENHANCED SPINE-AND-RIB PROCESS FOR EVALUATION OF FORMATION DENSITY

(71) Applicant: Baker Hughes Oilfield Operations LLC, Houston, TX (US)

(72) Inventors: Bair Banzarov, Novosibirsk (RU); Alexander Vinokurov, Novosibirsk (RU); Andreas Vogt, Celle; Lower Saxony (DE); Ilgizar Nasibullin, Bulgakovo (RU); Ilya Blinov, Tyumen (RU); Andre Haeussler, Celle (DE)

(21) Appl. No.: 18/038,837

(22) PCT Filed: May 24, 2023
(86) PCT No.: PCT/US23/23305

§ 371 Date: May 25, 2023

(30) Foreign Application Priority Data
May 26, 2022 (EA) 202291316

(51) Int. Cl. E21B 44/00; E21B 7/06; E21B 49/00; G01V 5/08

(52) U.S. Cl. CPC E21B 44/00; E21B 7/06; E21B 49/00; G01V 5/08; E21B 2200/20; E21B 2200/22

(57) ABSTRACT

Methods for determining formation density of downhole formations include obtaining first density data (ρ_{SS}) using a short-spaced detector configured to detect reflections of a signal transmitted into the downhole formation, obtaining second density data (ρ_{LS}) using a long-spaced detector configured to detect reflections of the transmitted signal from the downhole formation, wherein the long-spaced detector is located a greater distance from a source than the short-spaced detector, and determining if a measured data point based on ρ_{SS} and ρ_{LS} falls within a unity area of a spine-and-rib plot. When the measured data point falls within the unity area, the formation density using a first mathematical relationship is determined and when the measured data point falls outside the unity area, the formation density using a second mathematical relationship different from the first mathematical relationship is determined.

### CROSS REFERENCE TO RELATED APPLICATIONS

This application claims the benefit of PCT application number PCT/US23/23305, filed on May 24, 2023 and Eurasian Application No. 202291316, filed on May 26, 2022, which is incorporated herein by reference in its entirety.

### BACKGROUND

Embodiments described herein relate generally to downhole exploration and production efforts in the resource recovery industry and more particularly to techniques for geosteering and determining formation density while drilling.

Downhole exploration and production efforts involve the deployment of a variety of sensors and tools. The sensors provide information about the downhole environment, for example, by collecting data about temperature, density, saturation, and resistivity, among many other parameters. This information can be used to control aspects of drilling and tools or systems located in the bottom hole assembly, along the drillstring, or on the surface.

### SUMMARY

Some embodiments of the present invention are directed to methods for determining formation density of downhole formations. The methods include obtaining first density data (ρ_{SS}) using a short-spaced detector configured to detect reflections of a signal transmitted into the downhole formation, obtaining second density data (ρ_{LS}) using a long-spaced detector configured to detect reflections of the transmitted signal from the downhole formation, wherein the long-spaced detector is located a greater distance from a source than the short-spaced detector, and determining if a measured data point based on ρ_{SS} and ρ_{LS} falls within a unity area of a spine-and-rib plot. When the measured data point falls within the unity area, the formation density using a first mathematical relationship is determined and when the measured data point falls outside the unity area, the formation density using a second mathematical relationship different from the first mathematical relationship is determined.

Some embodiments of the present invention are directed to methods for determining formation density of downhole formations that include generating tool model data of a downhole tool to be used for measuring density of the downhole formation, generating requirement data comprising information associated with standoff values, mud weights, and range of potential formation densities, using the tool model data and the requirement data, generating a set of responses of a short-spaced detector and a long-spaced detector, generating a set of basic ribs of a spine-and-rib chart based on the set of responses, obtaining a set of first mathematical relationships based on the basic ribs, defining a unity area of the spine-and-rib chart based on the basic ribs, and generating a lookup table based on the set of first mathematical relationships.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

Referring now to the drawings wherein like elements are numbered alike in the several figures:

FIG. 1 depicts a schematic illustration of a wellbore operation system that can incorporate embodiments of the present disclosure;

FIG. 2 depicts a block diagram of a processing system, which can be used for implementing more embodiments of the present disclosure;

FIG. 3A is a schematic representation of a downhole tool arranged proximate a formation and configured to measure a density of the formation;

FIG. 3B illustrates the downhole tool of FIG. 3A as offset from the formation by a standoff gap;

FIG. 4 illustrates an example of a spine-and-rib chart in accordance with an embodiment of the present disclosure;

FIG. 5 is a flow process for establishing an algorithm to determine formation density in accordance with an embodiment of the present disclosure;

FIG. 6A is an example of a spine-and-rib chart in accordance with an embodiment of the present disclosure;

FIG. 6B is the same spine-and-rib chart of FIG. 6A, illustrating a unity area defined in accordance with an embodiment of the present disclosure;

FIG. 7A is a schematic plot of a portion of a spine-and-rib chart illustrating an iterative process for populating a lookup table in accordance with an embodiment of the present disclosure;

FIG. 7B illustrates a plot of a portion of the iterative process shown in FIG. 7A for determining a point on an unknown rib;

FIG. 7C illustrates a plot of a portion of the iterative process shown in FIG. 7A for determining a point on an unknown rib;

FIG. 8 is a flow process for determining formation density in accordance with an embodiment of the present disclosure; and

FIG. 9 is a schematic plot representing a third-order polynomial used to determine formation density in accordance with an embodiment of the present disclosure.

### DETAILED DESCRIPTION

Modern bottom hole assemblies (BHAs) are composed of several distributed components, such as sensors and tools, with each component performing data acquisition and/or processing of a special purpose. An example of one type of data acquired can include downhole survey data and/or formation density information.

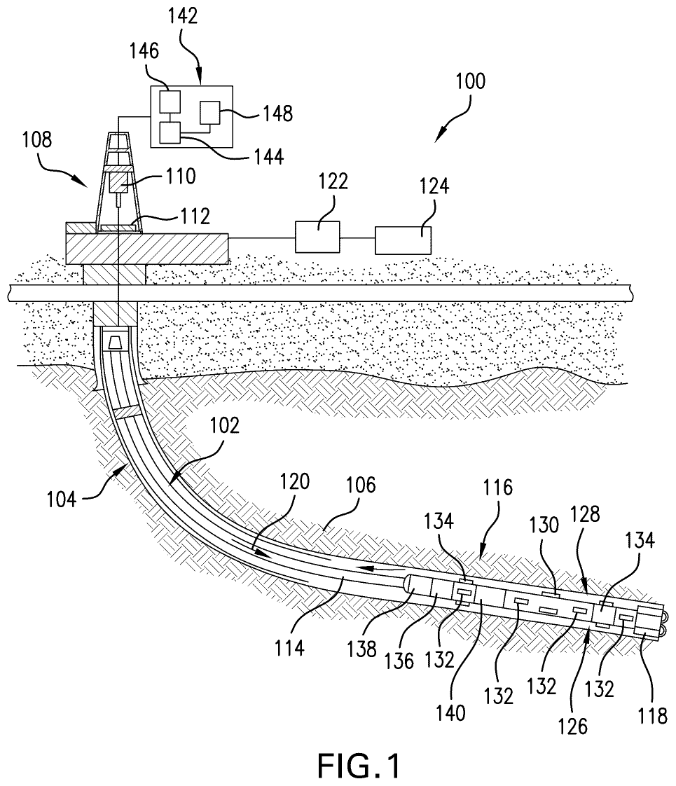

FIG. 1 illustrates an embodiment of a system 100 for performing an energy industry operation (e.g., subsurface drilling, measurement, stimulation, and/or production). The system 100 includes a borehole string 102 that is shown disposed in a well or borehole 104 that penetrates at least one earth formation 106 during a drilling or other downhole operation. As described herein, “borehole” or “wellbore” refers to a hole that makes up all or part of a drilled well. It is noted that the borehole 104 may include vertical, deviated, and/or horizontal sections, and may follow any suitable or desired path. As described herein, “formations” refer to the various features and materials (e.g., geological material) that may be encountered in a subsurface environment and surround the borehole 104.

The borehole string 102 is operably connected to a surface structure or surface equipment such as a drill rig 108, which includes or is connected to various components such as a surface drive 110 (also referred to as top drive) and/or rotary table 112 for supporting the borehole string 102, rotating the borehole string 102, and lowering string sections or other downhole components into the borehole 104. In one embodiment, the borehole string 102 is a drill string including one or more drill pipe sections 114 that extend downward into the borehole 104 and is connected to one or more downhole components (downhole tools), which may be configured as a bottomhole assembly (BHA) 116. The BHA 116 may be fixedly connected to the borehole string 102 such that rotation of the borehole string 102 causes rotation of the BHA 116.

The BHA 116 includes a disintegrating device 118 (e.g., a drill bit), which in this embodiment is driven from the surface, but may be driven from downhole (e.g., by a downhole mud motor). The system 100 may include components to facilitate circulating fluid 120, such as drilling mud, through an inner bore of the borehole string 102 and an annulus between the borehole string 102 and a wall of the borehole 104. For example, in this illustrative embodiment, a pumping device 122 is located at the surface to circulate the fluid 120 from a mud pit or other fluid source 124 into the borehole 104 as the disintegrating device 118 is rotated (e.g., by rotation of the borehole string 102 and/or a downhole motor).

In the illustrative embodiment shown in FIG. 1, the system 100 includes a steering assembly 126 configured to steer or direct a section of the borehole string 102 and the disintegrating device 118 along a selected path. The steering assembly 126 may have any configuration suitable to direct or steer the drill string 102. Examples of steering assemblies include, without limitation, steerable motor assemblies (e.g., bent housing motor assemblies), whipstocks, turbines, and rotary steerable systems.

In one non-limiting embodiment, the steering assembly 126 is configured as a rotary steering assembly forming the BHA 116 or part of the BHA 116. The steering assembly 126 includes a non-rotating or slowly-rotating sleeve 128 that includes one or more radially extendable pads 130 (extendable in a direction perpendicular to a longitudinal axis of the sleeve). The pads 130 may be located at different circumferential locations on the sleeve 128 and are adjustable individually or in combination to deflect the disintegrating device 118 by engaging the wall of the borehole 104.

The system 100 may also include a controller configured to operate or control operation of the pads 130 based on directional information derived from directional sensors located in the BHA 116 and/or the borehole string 102. The directional sensor(s) may be arranged at, in, or near the steering assembly 126. The directional sensor(s) can include one or more gyroscopes (e.g., gyroscope sensors or earth rate sensor sensors), and also include one or more magnetometers (i.e., magnetic field sensors) and/or one or more accelerometers (e.g., acceleration sensors and/or gravitational sensors).

In one embodiment, the system 100 includes one or more sensor assemblies 132 configured to perform measurements of parameters related to position and/or direction of the borehole string 102, the disintegrating device 118, and/or the steering assembly 126. As shown in FIG. 1, the sensor assemblies 132 may be located at one or more of various locations, such as on the sleeve 128, at or near the disintegrating device 118, and/or on other components of the borehole string 102 and/or the BHA 116. For example, a sensor assembly 132 can be located on one or more stabilizer sections 134 of the steering assembly 126. The sleeve 128 may be coupled to the borehole string 102 by a bearing assembly or other mechanism that allows rotation of the sleeve independent of the rotation of the borehole string, as will be appreciated by those of skill in the art.

The system 100 may include one or more of various tools or components configured to perform selected functions downhole such as performing downhole measurements/surveys (e.g., formation evaluation measurements, directional measurements, etc.), facilitating communications (e.g., mud pulser, wired pipe communication sub, etc.), providing electrical power and others (e.g., mud turbine, generator, battery, data storage device, processor device, modem device, hydraulic device, etc.). For example, the steering assembly 126 can be connected to one or more sensor devices, such as a gamma ray imaging tool 136. Such gamma ray imaging tool 136 may be used to measure formation density, for example.

In one embodiment, the system 100 includes a measurement device such as a logging while drilling (LWD) tool (e.g., for formation evaluation measurements) or a measurement while drilling (MWD) tool (e.g., for directional measurements), generally referred to as while-drilling tool 138. Examples of LWD tools include nuclear magnetic resonance (NMR) tools, resistivity tools, gamma (density) tools, pulsed neutron tools, acoustic tools, and various others. Examples of MWD tools include tools measuring pressure, temperature, or directional data (e.g., magnetometer, accelerometer, gyroscope, etc.). The steering assembly 126 or the system 100 can include other components, such as a telemetry assembly (e.g., mud pulser, wired pipe communication sub, etc.) or other downhole and/or surface components, systems, or assemblies.

In one non-limiting embodiment, during drilling, the sleeve 128 does not rotate or rotates at a rate that is less than the rotational rate of the disintegrating device 118 and other components of the steering assembly 128 and rotary table 112 or surface drive 110. The rate of rotation of the sleeve 128 may be denoted herein as “slow rotation.” It is noted that “slow” rotation is intended to indicate a rotational rate that is less than the drilling rotational rate and is not intended to be limiting to any specific rate. A “slowly-rotating” sleeve is a sleeve that rotates at the slow rotation rate.

The sleeve 128 can rotate at any suitable slow rotation rate that is less than the drilling rotation rate. In one embodiment, slow rotation of the sleeve 128 is a rate between about 1 and 10 revolutions per hour (RPH). In one embodiment, slow rotation is between about 10 and 50 RPH (60°/minute and 300°/minute). In yet another embodiment, slow rotation is about 1 and 50 RPH (6°/minute and 300°/minute).

One or more downhole components and/or one or more surface components may be in communication with and/or controlled by a processor such as a downhole processing unit 140 and/or a surface processing unit 142. The downhole processing unit 140 may be part of the BHA 116 or may be otherwise arranged on or part of or disposed on the borehole string 102. The surface processing unit 142 (and/or the downhole processing unit 140) may be configured to perform functions such as controlling drilling and steering, controlling the flow rate and pressure of the fluid 120, controlling weight on bit (WOB), controlling rotary speed (RPM) of the rotary table 112 or the surface drive 110, transmitting and receiving data, processing measurement data, and/or monitoring operations of the system 100. The surface processing unit 142, in some embodiments, includes an input/output (I/O) device 144 (such as a keyboard and a monitor), a processor 146, and a data storage device 148 (e.g., memory, computer-readable media, etc.) for storing data, models, and/or computer programs or software that cause the processor to perform aspects of methods and processes described herein.

In one non-limiting embodiment, the surface processing unit 142 is configured as a surface control unit which controls various parameters such as rotary speed, weight-on-bit, fluid flow parameters (e.g., pressure and flow rate), and other parameters or aspects of the system 100. The downhole processing unit 140, in some embodiments, may be a directional measurement controller or other processing device that controls aspects of operating the sensor assemblies 132, acquiring measurement data, and/or estimating directional parameters. The downhole processing unit 140 may also include functionality for controlling operation of the steering assembly 126 and/or other downhole components, assemblies, or systems. In one non-limiting embodiment, the method and processes described herein may be performed in the downhole processing unit 140 located within the borehole string 102 or the BHA 116.

In the embodiment of FIG. 1, the system 100 is configured to perform a drilling operation and a downhole measurement operation, and the borehole string 102 is a drill string. However, embodiments described herein are not so limited and may have any configuration suitable for performing an energy industry operation that includes or can benefit from directional measurements (e.g., completion operation, fracturing operation, production operation, re-entry operation, etc.).

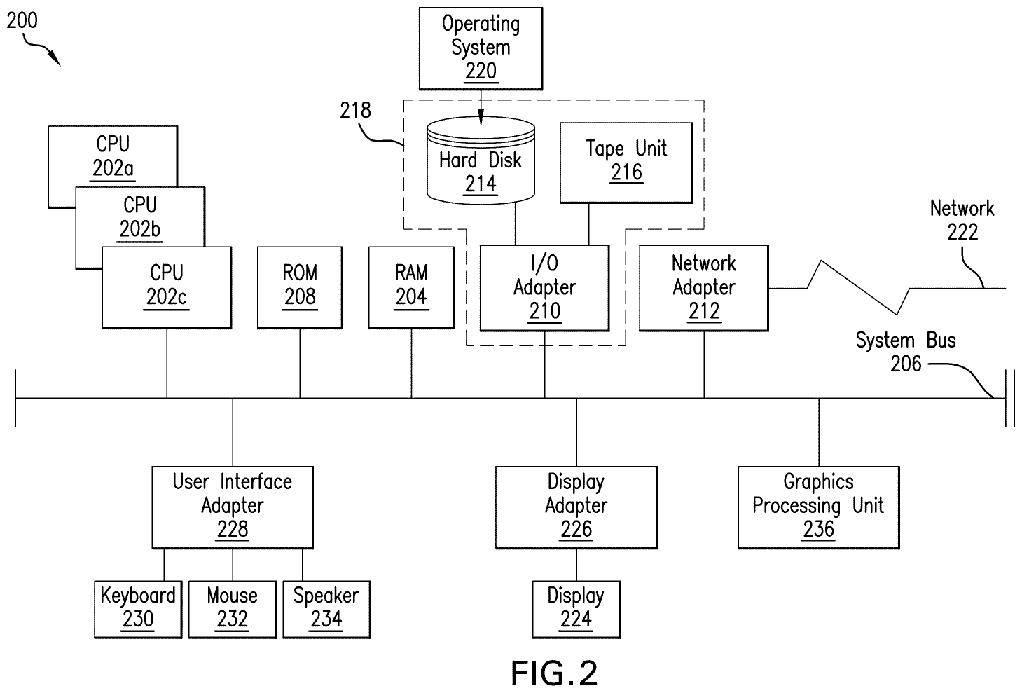

It is understood that embodiments of the present disclosure are capable of being implemented in conjunction with any other suitable type of computing environment now known or later developed. For example, FIG. 2 depicts a block diagram of a processing system 200 (e.g., surface processing unit 142 and/or downhole processing unit 140 of FIG. 1), which can be used for implementing the techniques described herein. In examples, the processing system 200 has one or more central processing units 202a, 202b, 202c, etc. (collectively or generically referred to as processor(s) 202 and/or as processing device(s) 202). In aspects of the present disclosure, each processor 202 can include a reduced instruction set computer (RISC) microprocessor. The processor(s) 202, as shown, are coupled to system memory (e.g., random access memory (RAM) 204) and various other components via a system bus 206. Read only memory (ROM) 208 is coupled to the system bus 206 and can include a basic input/output system (BIOS), which controls certain basic functions of the processing system 200.

Further illustrated in FIG. 2 are an input/output (I/O) adapter 210 and a network adapter 212 coupled to the system bus 206. The I/O adapter 210 can be a small computer system interface (SCSI) adapter that communicates with a memory, such as a hard disk 214 and/or a tape storage drive 216 or any other similar component(s). The I/O adapter 210 and associated memory, such as the hard disk 214 and/or the tape storage device 216, may be collectively referred to herein as a mass storage 218. An operating system 220 for execution on the processing system 200 can be stored in the mass storage 218. The network adapter 212 may be configured to interconnect the system bus 206 with an outside network 222 enabling the processing system 200 to communicate with other systems and/or remote systems (e.g., internet, extranet, and/or cloud-based systems).

A display (e.g., a display monitor) 224 is connected to the system bus 206 by a display adaptor 226, which can include, for example, a graphics adapter to improve the performance of graphics intensive applications and a video controller. In one aspect of the present disclosure, the adapters 210, 212, and/or 226 can be connected to one or more I/O busses that are connected to system bus 206 via an intermediate bus bridge (not shown), as will be appreciated by those of skill in the art. Suitable I/O buses for connecting peripheral devices such as hard disk controllers, network adapters, and graphics adapters typically include common protocols, such as the Peripheral Component Interconnect (PCI). Additional input/output devices are shown connected to the system bus 206 via a user interface adapter 228 and the display adapter 226. For example, as shown, a keyboard 230, a mouse 232, and speaker 234 can be interconnected to the system bus 206 via the user interface adapter 228, which can include, for example, a Super I/O chip integrating multiple device adapters into a single integrated circuit.

In some aspects of the present disclosure, and as shown, the processing system 200 includes a graphics processing unit 236. Graphics processing unit 236 may be a specialized electronic circuit designed to manipulate and alter memory to accelerate the creation of images in a frame buffer intended for output to a display (e.g., display 224). In general, the graphics processing unit 236 is very efficient at manipulating computer graphics and image processing and has a highly parallel structure that makes it more effective than general-purpose CPUs for algorithms where processing of large blocks of data is done in parallel.

Thus, as configured herein, the processing system 200 includes processing capability in the form of processors 202, storage capability including system memory (e.g., RAM 204 and mass storage 218), input means such as keyboard 230 and mouse 232, and output capability including speaker 234 and display 224. In some aspects of the present disclosure, a portion of system memory (e.g., RAM 204 and mass storage 218) may be configured to collectively store an operating system (e.g., operating system 220) to coordinate the functions of the various components shown in the processing system 200.

It will be appreciated that the processing system 200 of FIG. 2 is presently described as a surface system (e.g., surface processing unit 142 of FIG. 1). However, it will be appreciated that similar electronic components may be employed in downhole systems (e.g., as part of a BHA and/or downhole processing unit 140). In such configurations, certain features of the processing system may be omitted. For example, in a downhole BHA system, the user interface components may be omitted. Further, the system bus may be arranged to span multiple different downhole components and the network connection may be a communication means (e.g., telemetry, wired connection, wireless connection, or the like) that is configuration to enable communication between a surface system and the downhole BHA system.

Embodiments of the present disclosure are directed to techniques for evaluation of formation density using gamma density tools and the like. Conventionally, downhole density measurement tools, such as gamma density tools, are configured with a single gamma ray source and two scintillation detectors separated by an axial distance along a tool body. Due to variations in formation materials and composition, different densities are present and such different densities may result in different behaviors relative to the measurement process (e.g., Δρ responses may vary depending on formation density and sensor position, for example). Because of this variation, conventional algorithms tend to be inaccurate if the density of a measured formation is too high or too low (i.e., outside of a standard range of densities). In view of this, the methods and processes described herein are based on integration of two different methods, both based on spine-and-rib representation of density tool responses. Such spine-and-rib methods are more general as compared to the Δρ based approaches of conventional systems.

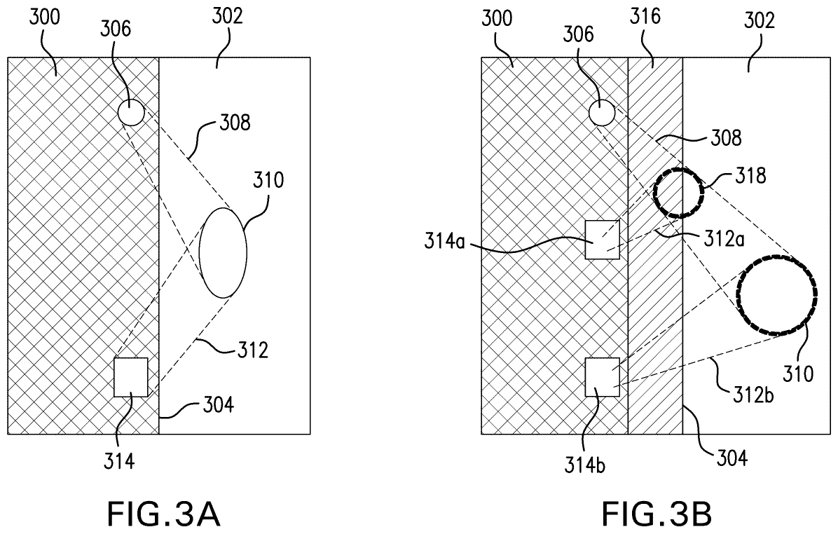

Referring now to FIGS. 3A-3B, schematic illustrations of a downhole tool 300 in accordance with an embodiment of the present disclosure are shown. The downhole tool 300 is arranged within a borehole and positioned proximate a formation 302. In the illustration of FIG. 3A, the downhole tool 300 is arranged in contact with the formation 302 (e.g., borehole wall 304). In this configuration, a radiation source 306 (such as a gamma source) will transmit a radiation 308 (e.g., gamma rays) into the formation 302 where the radiation 308 will interact with a formation area 310 and will be scattered (e.g. Compton scattering) resulting in a scattered radiation 312 which is detected by a detector 314 of the downhole tool 300. Because the downhole tool 300 is arranged in contact with the formation 302 along the borehole wall 304, a single detector 314 may be used and the measurement made by such detector 314 represents a formation density.

However, as shown in FIG. 3B, the downhole tool 300 may not be arranged in contact with the formation 302 along the borehole wall 304. As appreciated by those of skill in the art, during a drilling operation, an annulus between the downhole tool 300 and the borehole wall 304 may be filled with drilling fluid 316 (e.g., drilling mud). When the source 306 projects the transmitted radiation 308 toward the formation 302, the radiation will be scattered by the fluid as well as the formation 302 in area 318. The transmitted radiation 308 will continue to pass into the formation 302 and interact with the formation in area 310. In this configuration, the downhole tool 300 may include a first detector 314a and a second detector 314b. As shown, the first and second detectors 314a, 314b are arranged at different axial positions (e.g., distance) from the source 306. This difference in axial position relative to the source 306 enables detection of a first scattered radiation 312a and a second scattered radiation 312b. It should be noted that when the downhole tool 300 is arranged against the borehole wall 304, the first and second scattered radiation 312a, 312b will be the same or equal, which is indicative of the actual density of the formation 302.

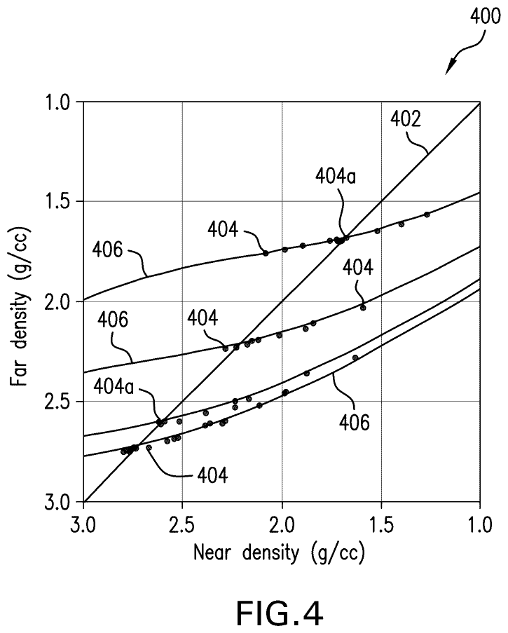

Referring now to FIG. 4, a schematic plot illustrating a spine-and-rib chart 400 of formation density is illustratively shown. The x-axis represents a density measurement made at a first detector (e.g., first detector 314a shown in FIG. 3B) and may be referred to as a near detector density measurement. The y-axis represents a density measurement made at a second detector (e.g., second detector 314b shown in FIG. 3B) and may be referred to as a far detector density measurement. During a measurement process, both the first and second detectors are employed to obtain density measurements, with such data plotted on the spine-and-rib chart 400. A spine 402 is shown having a linear relationship where the first (near) detector density measurement is equal to the second (far) detector density measurement. The spine 402 represents the true formation density and would be the plotted data when the downhole tool is in contact with the borehole wall such that there is no fluid barrier/reflection, and thus the first and second detector density measurements are the same or equal.

However, when the downhole tool is offset from the borehole wall, and thus drilling fluid is present along a radiation path from a source to the detectors, two different density measurements are made at the two different detectors. When such data is plotted on the spine-and-rib chart 400, datapoints 404 may be plotted. If the first (near) detector density measurement and the second (far) detector density measurement are equal, such datapoints 404a are plotted and will fall on the spine 402. This situation is present when the downhole tool comes into contact with the borehole wall, and thus no fluid is present between the downhole tool and the formation. However, because the data may be collected during a rotational operation (e.g., during drilling), the downhole tool may move relative to the borehole wall such that when some data is collected there is a variable amount of fluid between the downhole tool and the formation. When the downhole is offset from the borehole wall, the datapoints 404 will be plotted at locations away from the spine 402 because the density values between the first and second detectors will be different. The term spine-and-rib chart or spine-and-rib plot in this application are equivalent expressions for the graphical presentation provided in FIG. 4. The term plot or chart include graphical presentations on a sheet of paper or on an electronic monitor or display as well as a set of datapoints, such as provided by datapoints 404, stored in a memory of a data processing device.

When a given formation is measured using the radiation source and detectors, as the downhole tool rotates and captures data, the datapoints 404 may be plotted along a rib 406. The ribs 406 represent a relationship between the measured data of the first detector and the measured data of the second detector that represents a single formation of a given density. Because of the presence of the drilling fluid and two different radiation paths, the datapoints 404 will vary between zero distance (e.g., no gap) where such datapoints fall on the spine 402 and points that deviate from the spine 402 along a respective rib 406 and offset from the spine 402. Each rib 406 represents a mathematical fit of density relationship (between near and far detectors) for a given formation density. That is, although the formation density is static, due to the rotation of the downhole tool and variation in the thickness of the fluid portion (zero to a couple inches) and varying standoff between downhole tool 300 and the borehole wall 304, the measured densities will not be equal and result in datapoints 404 along a respective rib 406.

To determine the actual density from the obtained data, the datapoints 404 may be correlated to a best-fit relationship to determine the intersection of the respective rib and the spine 402, particularly if no datapoints 404 fall on the spine 402. Accordingly, embodiments of the present disclosure are directed to fit the datapoints 404 into best fit ribs 406, and a plurality of ribs 406 may be used to determine the intersection points of the best fit ribs 406 with the spine 402. By knowing the intersections with the spine 402, the formation density may be obtained.

Because the ribs cannot be known in advance for a given formation, part of the process involves determining which rib a given datapoint is part of. Accordingly, in accordance with some embodiments of the present disclosure, a lookup table or reference dataset may be generated. The reference dataset may be calibrated for a specific tool and operational conditions (e.g., the specific tool and a variety of gap distances and/or types of drilling fluid). Then, when density data is collected in the field, the collected data may be compared against the reference dataset to determine a specific rib that the datapoint will fall upon.

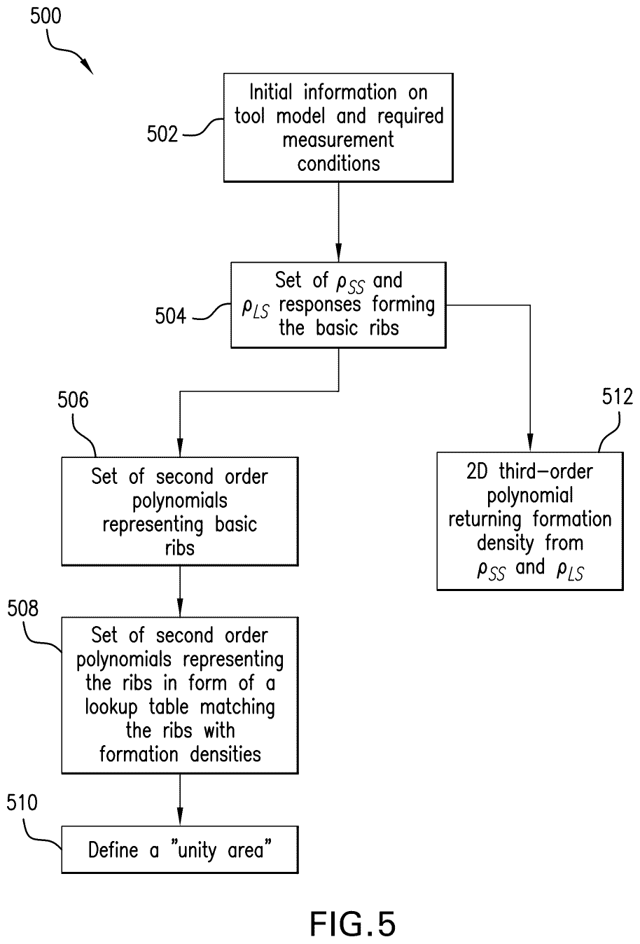

Referring now to FIG. 5, a flow process 500 for preparing data for a density evaluation algorithm in accordance with an embodiment of the present disclosure is shown. The flow process 500 provides a preliminary simulation of basic data and the development of coefficients for an in situ algorithm for use in field applications, such as while-drilling operations and using such information (i.e., density information) for performing geosteering or other downhole operations (such as drilling, logging, reentry, fracturing). Other applications that may employ flow process 500 or other embodiments of the present disclosure may include, without limitation, wireline application/tools and/or inspection applications/tool. The flow process 500 may be performed a single time (for a given tool) and the resulting data can be saved in a memory of the tool when the tool is prepared for downhole operations. As described herein, the flow process 500 includes a Monte Carlo simulation of a large amount of data (preliminary defined basic data points) to generate an accurate representation of the tool relative to a variety of different formation densities, offset gaps (standoff), and drilling fluids. This may be performed in a laboratory and/or through simulations The obtained data set can then be used for building a detailed lookup table that assists in evaluation of measured density data of a formation with better accuracy than conventional delta-rho algorithms allow. In embodiments, alternative methods may be used to derive the preliminary defined basic data points, such as a multidimensional solution of the Boltzmann equation, machine learning methods, laboratory measurements or offset data from previously logged boreholes.

At block 502, initial information regarding a tool model and requirement measurement conditions is established. The initial information can include, for example and without limitation, a tool model that relates to the type of sensors, detectors, radiation sources, tool size, tool materials, etc., and any aspects that may impact a measurement when using such a tool The tool, in some non-limiting embodiments, is a gamma ray density measurement tool. The requirement measurement conditions can include ranges of formation densities that may be measured by the tool when operated in the field, standoff values (offset gaps), mud weights, and the like. The formation density information may be obtained from known sources for various types of formations (e.g., anhydrite, limestone, anthracite, etc.). The standoff values represent the gap or spacing between the radiation source and the borehole wall, which can range from zero (when the tool contacts the borehole wall) up to a maximum standoff gap depending on downhole tool outer diameter and borehole diameter. When used downhole, the gap is filled with drilling fluid or drilling mud. When the standoff gap changes in dimension (e.g., when the tool moves closer to or farther from the borehole wall), the density measurement will change due the interference from the radiation passing though the drilling mud. The mud weight information may be obtained from known sources, such as existing mud weight lookup tables associated with different types of drilling fluids.

At block 504, from the initial information, a set of simulation measurement responses may be obtained. The responses may be obtained in the form of a table or the like, where a set of responses for a first (near) detector may be referred to as an SS response (short-spaced detector). Similarly, a set of responses for a second (far) detector may be referred to as an LS response (long-spaced detector). In these datasets, when the simulation has the tool in contact with a borehole wall the responses of the two will be equal (i.e., short-spaced detector density is equal to long-spaced detector density). However, as the tool is separated from the borehole, the two values will no longer be equal, and thus a dataset is prepared to represent the various positions of the tool relative to the borehole wall (various offset gaps) and such operation with different drilling fluids with different densities. From data and simulations thereof, at block 504, a set of basic ribs (of a spine-and-rib plot) may be established. The basic ribs calculated at block 504 represent the various different density plots for a variety of conditions (formation density, offset gap, mud properties) to which a given tool may be exposed downhole.

Blocks 502, 504, may be preliminary defined basic data points and simulation. In such processes, extensive simulation of the SS and LS tool responses may be conducted to develop the basic ribs (block 504).

At block 506, the basic ribs obtained at block 504 are converted into a set of best-fit equations. These best-fit equations may be a first mathematical relationship used in the process. In some non-limiting examples, the first mathematical relationship may be a second-order polynomial relationship. That is, a set of best fit curves are fit to the basic ribs obtained at block 504. In this example, the ribs of a density spine-and-rib chart may be represented by second-order polynomials. It will be appreciated that other mathematical relationships may be used without departing from the scope of the present disclosure. For example, any continuous or piecewise defined function may be used (e.g., including terms of polynomials and higher-order polynomials, rational, trigonometric, exponential, square or higher-order root or logarithmic relationships, piecewise function (spine)).

At block 508, the set of first mathematical relationships (e.g., set of second-order polynomials) that represent the basic ribs obtained at block 506 are assembled into a lookup table that associates or matches each rib with a known formation density (e.g., based on the simulations the density is known). Block 508 includes the development of the mathematical relationships representing ribs for arbitrary formation density within expected ranges. The basic ribs obtained at block 504 and the best fit relationships obtained from block 506 are used to build secondary ribs, also referred to herein as interpolated ribs, that form a full data set for the constructed lookup table. For example, extrapolation or interpolation from or between the basic ribs allows for determination or calculation of values that fall between the basic ribs, thus expanding the scope and completeness of the lookup table. Examples of such interpolation process are described herein. The complete set of basic and secondary ribs may be assembled into a lookup table for use in embodiments of the present disclosure.

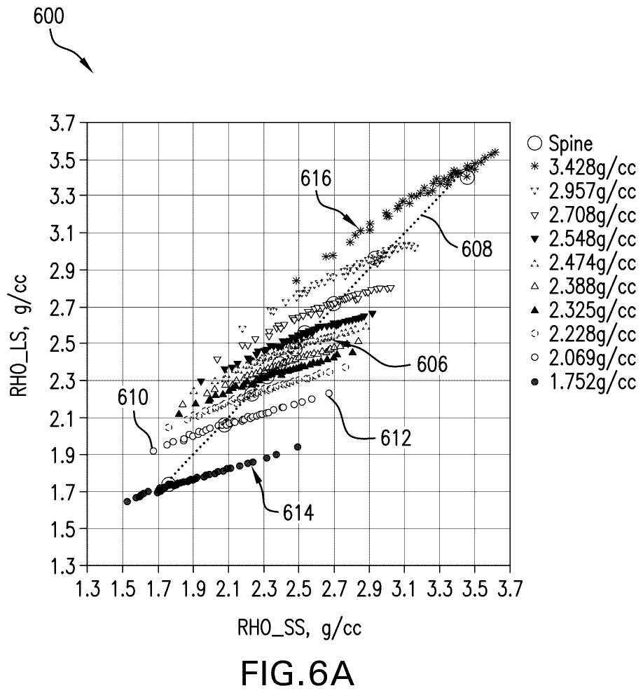

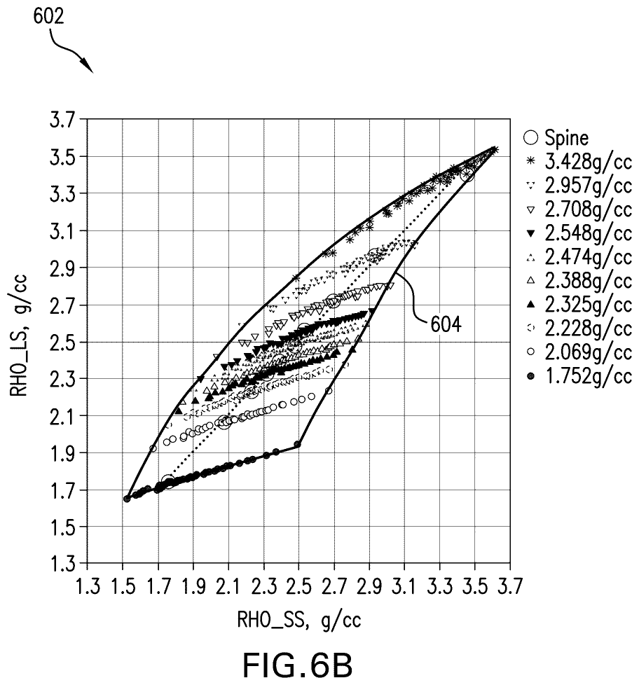

At block 510, a unity area of a spine-and-rib chart is defined. This is an area bounded by two ribs corresponding to the highest and lowest densities and two point sets corresponding to left and right ends of the ribs (e.g., as shown in FIGS. 6A-6B).

At block 512, from the data and simulation of blocks 502, 504, a second mathematical relationship may be obtained, with the second mathematical relationship being different than the first mathematical relationship. For example, in a non-limiting example, a two-dimensional (2D) third order polynomial may be obtained (e.g., distinguishing from a first mathematical relationship that is a second order polynomial). This second mathematical relationship may be used, for example, for situations when a datapoint that is collected downhole does not fit within the unity area obtained at block 510. The second mathematical relationship is, in a simplistic representation, a function of the short-spaced detector density measurement and the long-spaced detector density measurement, and this function can be used to extract the actual formation density therefrom.

Referring now to FIGS. 6A-6B, density plots 600, 602 of a set of basic data points with simulated ribs are shown. FIG. 6A illustrates the simulated data (preliminarily defined basic data points) as plotted to form the ribs and FIG. 6B illustrates the boundary of a unity area 604 based on the plotted data. The data obtained to plot in plots 600, 602 may be obtained from simulations of various tool, formation, and mud properties and characteristics (mud composition, mud density). The data are used to plot set of ribs 606 and a spine 608. The boundary of the unitary area 604 depends on the formation density, the standoff, the drilling fluid (mud) density, and the downhole tool properties.

It is supposed that the formation density domain is a discrete set of values ranging from a minimum value (e.g., about 1.7 g/cc) to a maximum value (e.g., 3.4 g/cc). The range of values of the formation density domain may be established based on a set of values that are incremented from the minimum value to the maximum value (e.g., an increment of 0.001 g/cc). These densities are referred to as target densities and they lie on the spine 608. For each target density, a rib 606 is constructed that represents, (density response at near detector) and p, (density response at far detector) for mud densities between a set range of values (e.g., about 8 ppg to about 20 ppg, or the like) and standoffs between a set range of values (e.g., about 0 inches (i.e., contact) to about 1 inches) that represent a fluid gap between downhole tool and borehole wall. Radiation-transport simulations of a tool model provide both calibrated ρ_{SS} and ρ_{LS} values, as shown in FIG. 6A.

As shown in FIG. 6A, a series of basic ribs 606 are plotted, with a spine 608 illustrated as a linear relationship on the density plot 600 (e.g., block 504 of FIG. 5). Each basic rib 606 will have a datapoint that falls on the spine 608, where the LS and the SS detector densities are equal with this occurring when the standoff gap is zero. Each basic rib 606 includes a minimum datapoint 610 and a maximum datapoint 612. Further, the span of ribs 606 include a minimum rib 614 and a maximum rib 616. Each basic rib 606 may be approximated by a first mathematical relationship (e.g., second-order polynomial). From the plotted data, the right side (set of maximum basic datapoints 612), the top rib (maximum rib 616), the bottom rib (minimum rib 614), and the left side (set of minimum basic datapoints 610) form or define the unity area 604 where the lookup table of the ribs is defined, as shown in FIG. 6B.

As noted above, each basic rib may be represented by a first mathematical relationship. For example, in a second order polynomial relationship, each basic rib may be represented by the following:

$${ρ}_{LS} - a * {ρ}_{SS} * {ρ}_{SS} + b * {ρ}_{SS} + c \qquad ( 1 )$$

where a, b, and c are coefficients of each second-order polynomial, ρ_{LS} is the density as measured (simulated) at the far detector and p, is the density measured (simulated) at the near detector. The polynomial coefficients (a, b, and c) are tied to target densities (i.e., actual formation densities) forming a lookup table. Each rib 606 intersects the spine 608 at the point where both ρ_{SS} and ρ_{LS} are equal to an actual formation density ρ_{formation}. In FIGS. 6A-6B, the endpoints (left/right) of the ribs 606 correspond to a largest standoff value where the lightest mud is on the left end and the heaviest mud is on the right end. All basic ribs 606 built for all target densities form an area outlined as the unity area 604. It is assumed that the basic ribs 606 corresponding to different target densities do not intersect each other within the unity area 604. As such, each basic rib has a unique solution and a single point (intersection) on the spine 608 such that overlapping of values from one basic rib 606 to the next basic rib 606 does not occur.

In this example, from the plotted simulated data and the second-order polynomial relationship (1), a lookup table of formation density may be obtained. An example lookup table, illustrating the coefficients of relationship (1), is illustrated below in Table 1:

| Formation density | a | b | c |
|---|---|---|---|
| 1.700 | a₁ | b₁ | c₁ |
| 1.701 | a₂ | b₂ | c₂ |
| 1.702 | a₃ | b₃ | c₃ |
| . | . | . | . |
| . | . | . | . |
| . | . | . | . |
| 3.400 | aₙ | bₙ | cₙ |

From Table 1, it is shown that each formation density may be represented using the threes coefficients of the second-order polynomial relationship (1). In this example, the densities range from 1.700 g/cc up to 3.400 g/cc, with values at increments of 0.001 g/cc. Each row of coefficient values (a, b, and c) represents a unique basic rib that correlates or corresponds to a formation having the indicated density. As such, when the measured density values are obtained (ρ_{SS} and ρ_{LS}) and such values are not equal to each other, it is possible to determine which rib the value will be part of and from that the coefficients and formation density (ρ_{formation}) may be obtained.

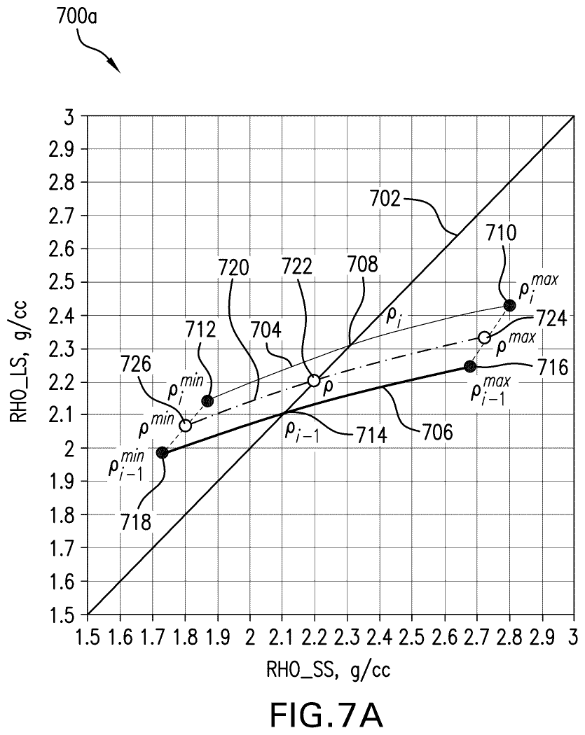

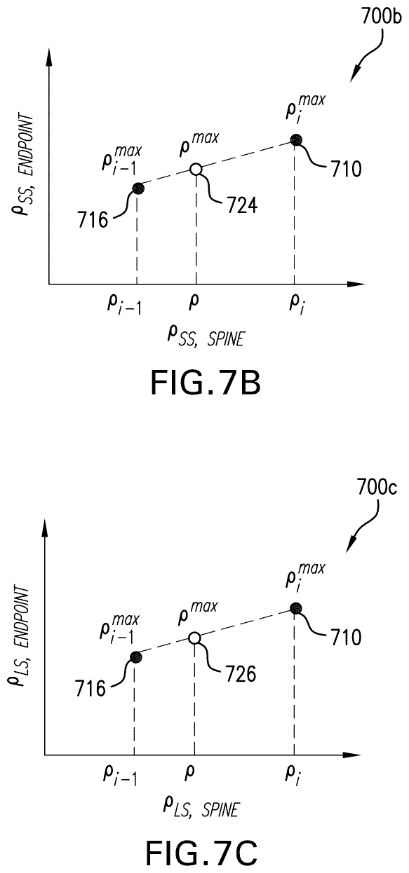

Referring now to FIG. 7A, an example spine-and-rib plot 700a illustrating a portion of the iterative process of establishing the lookup table of embodiments of the present disclosure is shown. Establishing data for every single density possibility may be time consuming and labor intensive, and thus, in some embodiments, an iterative process may be used to interpolate or extrapolate a set of coefficients for each density value shown in Table 1. In the spine-and-rib plot 700a, the x-axis is the short-spaced detector (near detector) measured density ρ_{SS} and the y-axis is the long-spaced detector (far detector) measured density ρ_{LS}. As noted above, when ρ_{SS}=ρ_{LS}, then the values represent the actual density and define a spine 702 for the range of densities.

As shown a first basic rib 704 represents the set of densities for a formation having a density 2.3 g/cc. This first basic rib 704 may be established from known information, lab testing, simulation, etc (preliminarily defined basic density data points). A second basic rib 706 represents the set of densities for formation having a density of 2.1 g/cc and may be based on similar information. Each of the first basic rib 704 and the second basic rib 706 may be first mathematical relationship representations (e.g., second-order polynomial) based on a minimum of three points of data.

For example, the first basic rib 704 is defined by a first datapoint 708 (Y) that is the actual density of the formation and thus falls on the spine 702. A tool measuring the density of such a formation (having a density of 2.3 g/cc) may register or measure datapoints that do not fall on the spine 702, as described above, due to a standoff gap and a drilling fluid between the tool and the formation. As such, a second datapoint 710 (ρₗ^{max}) representing the maximum ratio of ρ_{SS} and ρ_{LS} third datapoint 712 (ρₗ^{min}) representing the minimum ratio of ρ_{SS} to ρ_{LS}. From these three datapoints, a second-order polynomial (e.g., relationship (1)) may be obtained for this specific density (2.3 g/cc) of a formation.

The second basic rib 706 for a formation having a density of 2.1 g/cc is constructed in a similar fashion. That is, the second basic rib 706 is defined by a first datapoint 714 (ρₗ₋₁) that is the actual density of the formation and thus falls on the spine 702. A tool measuring the density of such a formation (having a density of 2.1 g/cc) may register or measure datapoints that do not fall on the spine 702, as described above, due to a standoff gap and a drilling fluid between the tool and the formation. As such, a second datapoint 716 (ρₗ₋₁^{max}) representing the maximum ratio of ρ_{SS} to ρ_{LS} and a third datapoint 718 (ρₗ₋₁^{min}) representing the minimum ratio of ρ_{SS} to ρ_{LS}. From these three datapoints, a second-order polynomial (e.g., relationship (1)) may be obtained for this specific density (2.1 g/cc) of a formation. In an alternative embodiment ρₗ^{max} and ρₗ^{min}, ρₗ₋₁^{max}, and ρₗ₋₁^{min} represent any kind of relationship between ρ_{SS} and ρ_{LS}, such as a difference, a summation, a multiplication, etc.

The datapoints 708-712, 714-718 that are used to define the first basic rib 704 and the second basic rib 706 may be known values from industry knowledge, simulations, testing, etc. However, a set of datapoints for a density between the two basic ribs 704, 706 may not be known in advance. As such, it may be difficult to determine a second-order polynomial or other first mathematical relationship for such formation density. For example, as shown in FIG. 7A, a third rib 720 represents a rib for a formation density that is not known in advance. However, through an iterative process, such as a Monte Carlo simulation-based approach for development of a rib dataset may be performed in accordance with embodiments of the present disclosure. For example, in accordance with some embodiments, a Monte Carlo N-Particle (MCNP) simulation of a basic dataset (e.g., datapoints 708-712, 714-718) with consecutive applying of an interpolation scheme may be performed for development of a full lookup table with matching ribs (interpolated ribs) with formation densities.

This is illustratively shown by the third rib 720. Because the spine 702 may be defined through the known basic dataset, a first datapoint 722 (ρ) may be readily identified at a target formation density (e.g., 2.2 g/cc) for interpolation. This first datapoint 722 may then be projected to form the third rib 720 (interpolated rib). A maximum value, represented as a second datapoint 724 (ρ^{max}) of the third rib 720 may be selected based on a relationship between the second datapoint 710 of the first basic rib 704 and the second datapoint 716 of the second basic rib 706 (e.g., similar to determining the first datapoint 722 of the third rib 720). Similarly, a minimum value, represented as a third datapoint 726 (ρ^{min}) of the third rib 720 may be selected based on a relationship between the third datapoint 712 of the first basic rib 704 and the third datapoint 718 of the second basic rib 706. With these three interpolated datapoints 722-726, a second-order polynomial representing the third rib 720 may be obtained and the coefficients thereof may be populated in a lookup table (e.g., Table 1). It is noted that the line connecting the second datapoints 710, 724, 716 may define a maximum bound of a unity area (e.g., 604 shown in FIG. 6B) and the line connecting the third datapoints 712, 726, 718 may define a minimum bound of the unity area.

In sum, for each rib, a first point is obtained from the condition that ρ_{SS}=ρ_{LS}=ρ at the intersection of the spine and the rib. The second and the third points are the endpoints of the rib. To calculate the position of the endpoints we calculate their coordinates along ρ_{SS} and ρ_{LS} axes. For a rib that does not have known information, for the left endpoint, both coordinates are calculated using a linear interpolation between the left endpoints of the neighbor basic ribs, e.g. first basic rib 704 and second basic rib 706 (see FIG. 7A). The same is performed to determine the coordinates of the right endpoint of the rib. The whole algorithm for the calculation of the ribs points of an interpolated rib is given with equations Error! Reference source not found.—Error! Reference source not found.:

$${ρ}_{SS} = ρ \qquad ( 2 )$$

$${ρ}_{LS} = ρ \qquad ( 3 )$$

$${ρ}_{SS}^{min} = \frac{{ρ}_{i , SS}^{min} - {ρ}_{i - 1 , SS}^{min}}{{ρ}_{i , SS} - {ρ}_{i - 1 , SS}} \cdot ( {ρ}_{SS} - {ρ}_{i - 1 , SS} ) + {ρ}_{i - 1 , SS}^{min} \qquad ( 4 )$$

$${ρ}_{LS}^{min} = \frac{{ρ}_{i , LS}^{min} - {ρ}_{i - 1 , LS}^{min}}{{ρ}_{i , LS} - {ρ}_{i - 1 , LS}} \cdot ( {ρ}_{LS} - {ρ}_{i - 1 , LS} ) + {ρ}_{i - 1 , LS}^{min} \qquad ( 5 )$$

$${ρ}_{SS}^{max} = \frac{{ρ}_{i , SS}^{max} - {ρ}_{i - 1 , SS}^{max}}{{ρ}_{i , SS} - {ρ}_{i - 1 , SS}} \cdot ( {ρ}_{SS} - {ρ}_{i - 1 , SS} ) + {ρ}_{i - 1 , SS}^{min} \qquad ( 6 )$$

$${ρ}_{LS}^{max} = \frac{{ρ}_{i , LS}^{max} - {ρ}_{i - 1 , LS}^{max}}{{ρ}_{i , LS} - {ρ}_{i - 1 , LS}} \cdot ( {ρ}_{LS} - {ρ}_{i - 1 , LS} ) + {ρ}_{i - 1 , LS}^{min} \qquad ( 7 )$$

Equations (2)-(3) are used to establish the first point of an interpolated rib, and specifically, the point where ρ_{SS}=ρ_{LS}=ρ, and thus represents a point on a spine and also is equal to the actual formation density. Equations (4)-(5) are used to establish a minimum (left side) endpoint of an interpolated rib, and equations (6)-(7) are used to establish a maximum (right side) endpoint of the interpolated rib. FIG. 7B illustrates the equation (6) and FIG. 7C illustrates the equation (7). Wherein ρₗ^{max} and ρₗ^{min} are maximum and minimum preliminarily defined basic data points of the first basic rib 704, and ρₗ₋₁^{max} and ρₗ₋₁^{min} are maximum and minimum preliminarily defined basic data points of second basic rib 706 in the spin-and-rib plot.

In an example, non-limiting embodiment of the present disclosure, a lookup table is constructed from a set of basic datapoints which are used to create basic ribs. To build the ribs for target formation densities, it is assumed that there are M basic ribs that are obtained from a basic dataset (preliminarily defined basic data points). In this example, the basic densities may be referred to as ρ₁, ρ₂, . . . , ρ_{M}. It is possible that some of the target densities of a formation will appear in an interval between two known basic densities (e.g., between ρₗ₋₁ and ρₗ). In this example, may represent one of these target densities that falls between the basic ribs. A rib corresponding to a target density equal to ρ is constructed using a second-order polynomial or other first mathematical relationship, with any three points that belong to the rib being required to determine such polynomial or first mathematical relationship. These three points will allow derivation of a best-fit equation and thus identification of the rib that includes target density ρ (formation density of interest).

For a given target density ρ that falls between two known ribs, the first point may be obtained from a condition that ρ_{SS}=ρ_{LS}=ρ at the intersection of the spine and the target rib. In this non-limiting example, the second and the third points are the endpoints of the target rib (e.g., end points that bound the unity area). To calculate the position of the endpoints, the coordinates of such ribs are calculated along ρ_{SS} and ρ_{LS} axes. The short-spaced detector density of the right endpoint of a secondary/target rib (e.g., interpolated rib) is calculated using a linear interpolation between the short-spaced detector basic density right endpoints of the neighbor or adjacent basic ribs. The same is performed to determine the long-spaced detector density of the right endpoint of the secondary rib. As such, the right endpoint (both ρ_{SS} & ρ_{LS}) of a target rib may be calculated. A similar process may be used to determine the left endpoint (both ρ_{SS} & ρ_{LS}) of the secondary rib. In accordance with this example, by having both the left and right endpoints and a point on the spine, a second-order polynomial relationship for the target/secondary rib may be determined for density ρ.

The above process has been determined to be substantially functional and operational for various different muds. For example, for the same formation with different mud systems, the ribs are substantially the same. For example, a barite mud with high Pₑ (photoelectric absorption factor) and a calcite mud with low Pₑ both have ρ_{SS} and ρ_{LS} that remain at the same rib. As such, the above described process of establishing a lookup table based on a spine-and-rib process may be applied for a single mud system and then applied to any downhole mud system, as the specific mud does not significantly impact the measurements of ρ_{SS} and ρ_{LS} and determining appropriate ribs and spines therefrom. Stated another way, the process of generating a lookup table from a spine-and-rib process, as described herein, is independent of the mud system.

With the data obtained in the above processes, an algorithm for downhole use may be implemented to determine formation density in downhole operations. That is, during a drilling operation or other downhole operation, logging data may be obtained and processed to determine a rib of a spine-and-rib chart (either basic rib or interpolated rib) and extract out a formation density. The logging data may include gamma ray data which is based on a source projecting gamma ray radiation into a formation and two detectors separated axially along a tool that register scattered gamma radiation, as described above. The data may be compared to, for example, a unity area of such spine-and-rib chart. Based on the location of the obtained/measured density of ρ_{SS} and ρ_{LS}, it can be determined if such measurement falls within the unity area, and based on this, the density of the formation may be extracted.

In application, an applied algorithm based on a spine-and-rib chart may result in one of two mathematical methods. The selection of the mathematical method depends on the position of measured density values (ρ_{SS} and ρ_{LS}) on the spine-and-rib chart. If the obtained datapoints are within the unity area, a 1D method may be used, or a 2D method may be applied when the datapoint(s) are outside the unity area, as described herein.

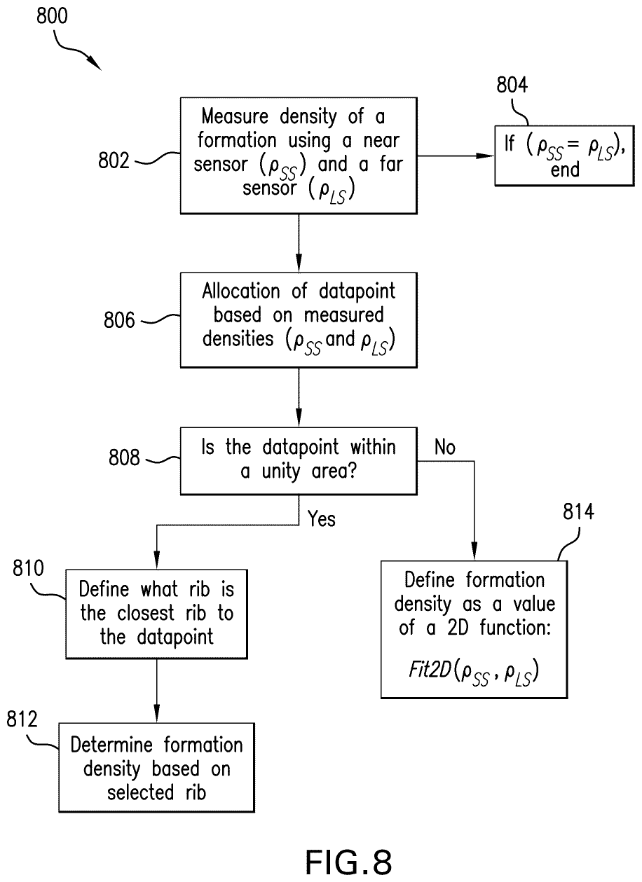

Referring now to FIG. 8, a flow process 800 for determining a formation density, in accordance with an embodiment of the present disclosure, is shown. The flow process 800 may be performed downhole in real time using downhole components including a density measurement tool and downhole processing components. The downhole processing components may include memory or other storage for storing information related to a spine-and-rib chart and/or a lookup table of coefficients associated with various formation densities, as described above. In some embodiments, the processing and density determining obtained from flow process 800 may be performed downhole in real time. In other embodiments, density information (e.g., datapoints) may be obtained downhole and either stored and processed later and/or transmitted (e.g. via the telemetry assembly) to the surface for processing at the surface. In some such embodiments, the processing and/or information related to the lookup table and/or spine-and-rib chart may be stored at a surface unit and/or at a location remote from where a drilling operation is performed. In any event, the collected density data is obtained and then processed with respect to a spine-and-rib chart and/or a lookup table.

At block 802, a downhole tool is used to obtain density information, including a near detector measured density (ρ_{SS}) and a far detector measured density (ρ_{LS}). The downhole tool includes, at least, a gamma ray source configured to emit gamma radiation into a formation. Arranged axially apart from the source is a first (near) detector or sensor configured to detect gamma radiation scattered by the formation (or borehole wall) and a second (far) detector or sensor configured to detect gamma radiation scattered by the formation. The first and second detectors are arranged at different distances from the gamma ray source, with the first detector being axially closer to the gamma ray source than the second detector. As such, at block 802, the downhole tool obtains two density measurements of a formation: a near detector measured density (ρ_{SS}) and a far detector measured density (ρ_{LS}).

A preliminary check is performed at block 804, to determine if the measured values are the same/equal or not. If (ρ_{SS}=ρ_{LS}), then the datapoints are both the same and would fall on a spine of a spine-and-rib chart. When (ρ_{SS}=ρ_{LS}), both values are equal to the formation density, and the flow process 800 can end. The two density measurement values are equal when the downhole tool is in direct contact with the formation (e.g., along a borehole wall), and thus there is no fluid separation. The flow process 800 may end with a determination of the formation density (ρ_{SS}=ρ_{LS}≤ρ_{formation}).

However, if the two density measurements at the two detectors are different (ρ_{SS}≠ρ_{LS}), then further processing of the datapoints is required to determine the formation density. Accordingly, at block 806, an allocation of the collected datapoints is made. The allocation may be assigning each of the collected datapoints based on (ρ_{SS} and ρ_{LS}) to a point on a spine-and-rib chart, which may be established as described above.

At block 808, it is determined if the assigned collected datapoint(s) fall within the unity area of the spine-and-rib plot. If the datapoint(s) fall within the unity area, the flow process continues to block 810 and, if not, the flow process 800 continues to block 814.

When the collected datapoint fall within the unity area, at block 810, the closest rib to the datapoint is determined. As described above, the unity area comprises a full spectrum of basic ribs from a minimum to a maximum (e.g., as shown in FIG. 6B). For example, for each basic rib from the lookup table, a distance between the collected datapoint and the basic rib is calculated. Further, the obtained distance is compared to each other obtained distance. The closest basic rib is selected at block 810.

At block 812, the formation density may be obtained from the selected basic rib and the associated information. Specifically, when a specific basic rib is selected at block 810, the first mathematical relationship of such selected basic rib may be determined and the formation density may be obtained, such as from a lookup table (e.g., Table 1). Such first mathematical relationship may be a second-order polynomial or other continuous or piecewise defined function (e.g., any one dimensional fit function). An algorithm may be used to find the set of coefficients in the lookup table that best describes the data point in the spine-and-rib plot that represents the measured density values ρ_{SS} and ρ_{LS} data. In embodiments the algorithm may include a neural network or machine learning. As described above, finding the set of coefficients that best describes the respective data point may involve determining additional coefficients, corresponding to interpolated ribs, if the respective data point is too far apart the next basic rib represented by a set of coefficients in the lookup table. To achieve a desired accuracy of the formation density the interpolated ribs may be determined at a grid that is in the range of the desired accuracy. This is, the number of interpolated ribs between two basic ribs needs to be great enough the ensure that the distance of the closest interpolated rib to a respective data point is equal to or smaller than the desired accuracy for the formation density that is to be determined (such as 0.001 g/cc to 0.002 g/cc).

If, at block 808, it is determined that the obtained datapoint is not within the unity area, the determination of the formation density requires a different approach. For example, in some embodiments, if the datapoint is not within the unity area, then the formation density may be obtained from a mathematical relationship based on the values of (ρ_{SS} and ρ_{LS}) as described herein.

Block 814 may involve a two dimensional algorithm that is based on a derivation of the formation density ρ_{formation} using some Fit2D function in dependence of ρ_{SS} and ρ_{LS}. For example, a second mathematical relationship (e.g., a third-order polynomial Poly2D) may be employed for the purpose of determining a formation density for values that are outside the unity area. When the second mathematical relationship is a third-order polynomial, the coefficients of such a third-order polynomial are determined to provide the best fit with the basic dataset (i.e., same basic dataset discussed above). It is assumed that the formation density ρ_{formation} depends on ρ_{SS} and ρ_{LS} as follows:

$${ρ}_{formation} = Poly 2 D ( {ρ}_{SS} , {ρ}_{LS} ) = a + b \cdot {ρ}_{SS} + c \cdot {ρ}_{LS} + d \cdot {ρ}_{SS}^{2} + e \cdot {ρ}_{LS}^{2} + f \cdot {ρ}_{SS} \cdot {ρ}_{LS} + g \cdot {ρ}_{SS}^{3} + h \cdot {ρ}_{LS}^{3} + i \cdot {ρ}_{SS} \cdot {ρ}_{LS}^{2} + j \cdot {ρ}_{SS}^{2} \cdot {ρ}_{LS} \qquad ( 8 )$$

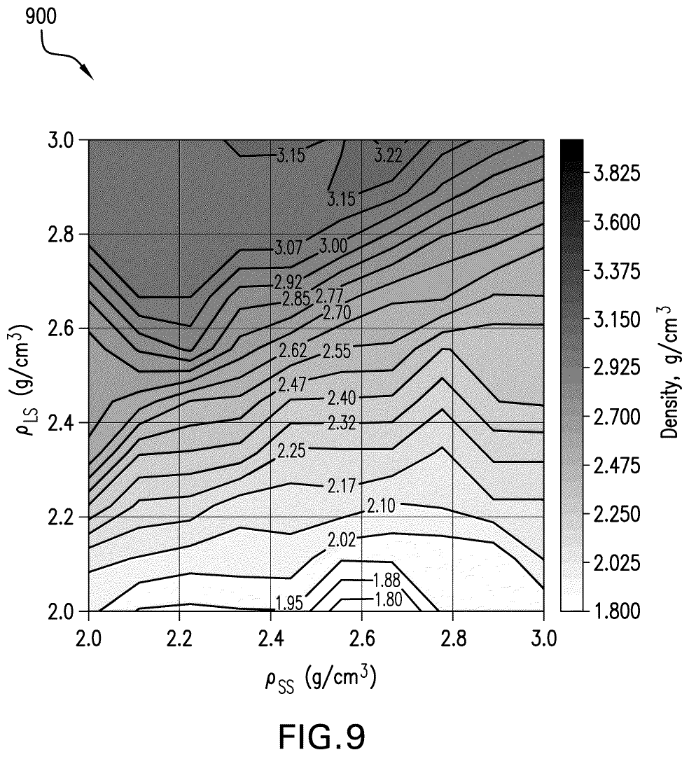

For a given basic dataset, the coefficients a, b, c, d, e, f, g, h, i, and j can be calculated, similar to the process described above. A fit to simulated data is shown in FIG. 9. FIG. 9 depicts a 2D plot 900 (e.g., contour graph) that illustrates a rib structure plotted in three dimensions (x-axis, y-axis, and contour/grading), with near detector density (ρ_{SS}) along an x-axis, far detector density (ρ_{LS}) along a y-axis, and formation density (ρ_{formation}) depicted as a gradient and/or contour on the plot 900. Plot 900 illustrates a contour graph illustrating corrected density versus short-spaced detector and long-spaced detector densities. Using equation (8) a similar lookup table as done in the above described process may be generated for densities outside the unity area. The term formation density in this application refers to electron density or density of mass.

In view of the above, the present disclosure is directed to providing improved processes for determining a formation density. One or more lookup tables are constructed from known data (e.g., field data, simulations, etc.). The lookup tables are correlated with a spine-and-rib chart that plots the known dataset as a set of known or basic ribs and a known spine. During a downhole operation, such as drilling, a gamma ray tool or other density measurement tool may be used to collect or measure density of a formation. From this, a measured ρ_{SS} and ρ_{LS} are obtained. A preliminary check is made to determine if the data point represented by the measured pair of ρ_{SS} and ρ_{LS} belongs to the unity area (FIG. 6B). If the measured data does not fall within the unity area, the ρ_{formation} value (e.g., formation density) is obtained using the second mathematical relationship (e.g., third-order polynomial relationship (e.g., equation (8))). However, if the measured data falls within the unity area of the spine-and-rib chart, the first mathematical relationship may be applied (e.g., second-order polynomial relationship (e.g., equation (1))). In one non-limiting example of application of a second-order polynomial algorithm, the values of all basic polynomials at the measured ρ_{SS} are obtained. With a known ρ_{SS}, the measured ρ_{LS} is used to determine which known basic rib is a best fit for the measured data. Then, using the lookup table, the density that corresponds to this polynomial is obtained and such determined is used to extract, determine, or calculated the formation density ρ_{formation}. Determining interpolated ribs may be required to improve the accuracy of the to be determined formation density. The closest basic rib may be at a distance to the data point representing the obtained density data ρ_{SS} and ρ_{LS} that is greater than a desired accuracy of the to be determined formation density (e.g 0.01 g/cc to 0.02 g/cc). Determining an interpolated rib using the method as described above provides an interpolated rib that is closest to the data point representing the obtained density data ρ_{SS} and ρ_{LS} and thus provides a more accurate formation density.

In view of the above, some embodiments of the present disclosure are directed to obtaining improved downhole survey data that is collected during a while-rotating operation. The use of gamma ray density information having two measured values, ρ_{SS} and ρ_{LS}, allows for determining of the actual density of a formation with high accuracy and a high confidence level. Through the creation of a lookup table and spine-and-rib chart, when a downhole operation is performed and two density values are obtained, the actual density of the formation may be extracted from such two density values. Embodiments of the present disclosure can determine a formation density even if such density would normally be difficult to obtain under prior determination processes.

The above described processes for determining formation density may be carried out in various downhole operations. For example, in some embodiments, the processes described herein may be implemented in downhole drilling tools and/or bottom-hole assemblies (BHAs) and carried out during a drilling process. As such, in real-time or near-real-time, formation density may be calculated downhole and actions based on such determination may be carried out in real-time or near-real-time. In some embodiments, information may be transmitted to the surface for a portion of the described processes to be performed at the surface, such as using a surface logging unit or other type of processor/controller. In such situations, the generated density information may be used by an operator to control a drilling operation or other downhole operation (such as other logging data acquisition in a wireline logging run). Furthermore, in some embodiments, the described processes may be performed using a wireline or inspection tool, which may be performed in a post-drilling or stop state of a drilling operation. The density information may be calculated and then subsequent actions may be performed based on such information, such as planning further drilling, adjusting a drilling plan (geo-steering), creating a fracking or other production plan based on the densities, or the like, as will be appreciated by those of skill in the art.

Although the above description focuses upon the details of a few limited or specific examples, those of skill in the art will appreciate that various features and aspects of the disclosed processes and/or systems may be modified without departing from the scope of the present disclosure. Furthermore, although generally described for the purpose of determining formation density, that present disclosed and described processes may be used for measuring bulk density, (electron) density, formation porosities, and/or other formation properties and/or characteristics that relate directly or indirectly to a density of a formation.

With respect to the disclosed processes, although a Monte Carlo simulation is described above regarding determination of the rib dataset, various other methods may be used without departing from the scope of the present disclosure. For example, a deterministic radiation transport calculation may be used as an alternative and/or in combination with the Monte Carlo simulation. Additionally, or alternatively, other (e.g., deterministic) simulation methods may be employed, and/or methods based on lab measurements, and/or field measurements can be used to generate the basic ribs of the present disclosure. Thus, it will be appreciated that the example processes and methods described above are for illustrative and explanatory purposes and are not intended to be limiting.

Furthermore, although the ribs and unity area described above are based on a specific second-order polynomial example, the best-fit relationships are not required to be limited to the specific described examples. For example, any suitable one-dimensional continuous or piecewise function can be used to represent the ribs. Similarly, any suitable two-dimensional continuous or piecewise function can be used to represent the relationship between bulk density and two apparent densities. It will be appreciated that the best-fit relationships may be in the form of functions containing exponential term(s), logarithmic term(s), or the like. In accordance with embodiments of the present disclosure, the ribs and unity area may be substantially defined by a first mathematical relationship and the information of density outside such defined area may be obtained using a second mathematical relationship that is different from the first mathematical relationship. The mathematical relationships may include, without limitation, continuous or piecewise defined functions, including terms of polynomials and higher-order polynomials, rational, trigonometric, exponential, square or higher-order root or logarithmic relationships. As such, those of skill in the art will appreciate that the present disclosure is not limited to the limited examples presented and that such examples are provided for explanatory and illustrative purposes.

Additionally, although described using a lookup table for evaluation of formation density in the downhole operation, such specific operation is not to be so limited. In this configuration, the use of a lookup table can provide savings on downhole microprocessor resources. However, in other embodiments, a real-time calculation may be performed for calculating the rib coefficients. In this configuration, the processing power or load on the downhole microprocessor resources may be increased, the downhole memory storage may be reduced. As such, there is a tradeoff between active downhole calculation (e.g., less required memory) and downhole lookup table (e.g., less required processing).

Set forth below are some embodiments of the foregoing disclosure:

Embodiment 1: A method for determining a formation density of a downhole formation, the method comprising: obtaining first density data (ρ_{SS}) using a short-spaced detector configured to detect a first scattered radiation of a radiation transmitted into the downhole formation by a radiation source; obtaining second density data (ρ_{LS}) using a long-spaced detector configured to detect a second scattered radiation of the radiation transmitted into the downhole formation, wherein the long-spaced detector is located a greater distance from the radiation source than the short-spaced detector; determining if a measured data point based on the obtained first density data (ρ_{SS}) and the obtained second density data (ρ_{LS}) falls within a unity area of a spine-and-rib plot; when the measured data point falls within the unity area, determining the formation density using the first density data (ρ_{SS}) and the second density data (ρ_{LS}) and a first mathematical relationship; and performing a wellbore operation using the determined formation density.

Embodiment 2: A method according to any prior embodiment, wherein the wellbore operation is a geosteering operation.

Embodiment 3: A method according to any prior embodiment, wherein the formation density is determined within a downhole tool, and the wellbore operation is a drilling operation, and wherein the first density data (ρ_{SS}) and the second density data (ρ_{LS}) are obtained during said drilling operation.

Embodiment 4: A method according to any prior embodiment, wherein the first mathematical relationship has the form of a second-order polynomial relationship ρ_{LS}=α·ρ_{SS}·ρ_{SS}+b·ρ_{SS}+c, where a, b, and c are coefficients defining basic ribs in the spine-and-rib plot, generating a lookup table using the coefficients, and using the lookup table to determine the formation density.

Embodiment 5: A method according to any prior embodiment, wherein the unity area of the spine-and-rib plot is defined by preliminary defined basic data points, and wherein the first mathematical relationship includes coefficients that define basic ribs in the spine-and-rib plot using the preliminary defined basic data points.

Embodiment 6: A method according to any prior embodiment, further comprising generating a lookup table containing the coefficients of the first mathematical relationship, and determining the formation density using the lookup table and identifying the coefficients that best fit the obtained first density data (ρ_{SS}) and the second density data (ρ_{LS}).

Embodiment 7: A method according to any prior embodiment, wherein determining the formation density using the lookup table includes a mathematical algorithm.

Embodiment 8: A method according to any prior embodiment, further comprising using a second mathematical relationship when the measured data point falls outside the unitary area.

Embodiment 9: A method according to any prior embodiment, wherein the preliminary defined basic data points include minimum basic data points and maximum basic data points, and the method further comprising assuming a target formation density, a first interpolation using two of the minimum basic data points and the target formation density, providing a first interpolated data point in the spine-and-rib plot, a second interpolation using two of the maximum basic data points and the target formation density, providing a second interpolated data point in the spine-and-rib plot, and wherein the first mathematical relationship performs a fit of the first interpolated data point, the second interpolated data point and the target formation density, and determining the formation density using the assumed formation density.

Embodiment 10: A method according to any prior embodiment, further comprising determining coefficients of the fitted first mathematical relationship of the first interpolated data point, the second interpolated data point and the target formation density, and using the determined coefficients to determine the formation density.

Embodiment 11: A method according to any prior embodiment, wherein the unity area is determined based on one of simulated data, and preliminarily measured data.

Embodiment 12: A method according to any prior embodiment, wherein the simulated data is generated using one of a Monte Carlo simulation, a multidimensional solution of the Boltzmann equation, and a neural network.

Embodiment 13: A method for determining a formation density of a downhole formation, the method comprising: generating tool model data of a downhole tool to be used for measuring density of the downhole formation; generating requirement data comprising information associated with standoff values, fluid densities, and range of potential formation densities, using the tool model data and the requirement data, generating a set of responses of a short-spaced detector and a long-spaced detector, generating a set of basic ribs of a spine-and-rib plot based on the set of responses, obtaining a first mathematical relationship based on the basic ribs, defining a unity area of the spine-and-rib plot based on the basic ribs, generating a lookup table based on coefficients of the first mathematical relationship, determining the formation density using the lookup table, and performing a wellbore operation using the determined formation density.

Embodiment 14: A method according to any prior embodiment, further comprising: measuring a first density ρ_{SS} and a second density ρ_{LS}, using the short-spaced detector and the long-spaced detector, respectively, wherein the determining of the formation density uses the measured first density ρ_{SS} and the measured second density ρ_{LS} based on at least one of the spine-and-rib plot and the lookup table and an interpolation, when the measured first formation density ρ_{SS} and the measured second formation density ρ_{LS}, fall within the unity area.

Embodiment 15: A method according to any prior embodiment, further comprising: determining that the measured first density ρ_{SS} and the measured second density ρ_{LS} do not fall within the unity area, and determining the formation density from a second mathematical relationship using the measured first density ρ_{SS} and the measured second density ρ_{LS}, wherein the second mathematical relationship is different from the first mathematical relationship.

Embodiment 16: A method according to any prior embodiment, wherein the first mathematical relationship has the form of a second-order polynomial: ρ_{LS}=α·ρ_{SS}·ρ_{SS}+b·ρ_{SS}+c, where a, b, and c are coefficients of the second-order polynomial.

Embodiment 17: A method according to any prior embodiment, further comprising determining the formation density from the lookup table based on the coefficients that best fit the measured first density ρ_{SS} and the measured second density ρ_{LS}.

Embodiment 18: A method according to any prior embodiment, wherein the second mathematical relationship has the form of a third-order polynomial relationship:

$${ρ}_{formation} = a + b \cdot {ρ}_{SS} + c \cdot {ρ}_{LS} + d \cdot {ρ}_{SS}^{2} + e \cdot {ρ}_{LS}^{2} + f \cdot {ρ}_{SS} \cdot {ρ}_{LS} + g \cdot {ρ}_{SS}^{3} + h \cdot {ρ}_{LS}^{3} + i \cdot {ρ}_{SS} \cdot {ρ}_{LS}^{2} + j \cdot {ρ}_{SS}^{2} \cdot {ρ}_{LS} ,$$

where ρ_{formation} is the formation density, and a, b, c, d, e, f, g, h, i, and j are coefficients of the third-order polynomial.

Embodiment 19: A method according to any prior embodiment, wherein the wellbore operation is a geosteering operation.

Embodiment 20: A method according to any prior embodiment, wherein the formation density is determined within a downhole tool, and the wellbore operation is a drilling operation, wherein the measured first density ρ_{SS} and the measured second density ρ_{LS} are obtained during said drilling operation.

The use of the terms “a” and “an” and “the” and similar referents in the context of describing the present disclosure (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifiers “about” and/or “substantially” used in connection with a quantity or property are inclusive of the stated value and has the meaning dictated by the context (e.g., it includes a degree of error associated with measurement of the particular quantity or property).

The teachings of the present disclosure can be used in a variety of well operations. These operations can involve using one or more treatment agents to treat a formation, the fluids resident in a formation, a wellbore, and/or equipment in the wellbore, such as production tubing. The treatment agents can be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers, etc. Illustrative well operations include, but are not limited to, hydraulic fracturing, stimulation, tracer injection, cleaning, acidizing, steam injection, water flooding, cementing, etc.

While the present disclosure has been described with reference to an exemplary embodiment or embodiments, it will be understood by those skilled in the art that various changes can be made, and equivalents can be substituted for elements thereof without departing from the scope of the present disclosure. In addition, many modifications can be made to adapt a particular situation or material to the teachings of the present disclosure without departing from the essential scope thereof. Therefore, it is intended that the present disclosure is not limited to the particular embodiment disclosed as the best mode contemplated for carrying out this present disclosure, but that the present disclosure will include all embodiments falling within the scope of the claims. Also, in the drawings and the description, there have been disclosed exemplary embodiments of the present disclosure and, although specific terms can have been employed, they are unless otherwise stated used in a generic and descriptive sense only and not for purposes of limitation, the scope of the present disclosure therefore not being so limited.

What is claimed:

1. A method for determining a formation density of a downhole formation, the method comprising:
obtaining first density data (ρ_{SS}) using a short-spaced detector configured to detect a first scattered radiation of a radiation transmitted into the downhole formation by a radiation source;
obtaining second density data (ρ_{LS}) using a long-spaced detector configured to detect a second scattered radiation of the radiation transmitted into the downhole formation, wherein the long-spaced detector is located a greater distance from the radiation source than the short-spaced detector;
determining if a measured data point based on the obtained first density data (ρ_{SS}) and the obtained second density data (ρ_{LS}) falls within a unity area of a spine-and-rib plot;
when the measured data point falls within the unity area, determining the formation density using the first density data (ρ_{SS}) and the second density data (ρ_{LS}) and a first mathematical relationship; and
performing a wellbore operation using the determined formation density.

2. The method of claim 1, wherein the wellbore operation is a geosteering operation.

3. The method of claim 1, wherein the formation density is determined within a downhole tool, and the wellbore operation is a drilling operation, and wherein the first density data (ρ_{SS}) and the second density data (ρ_{LS}) are obtained during said drilling operation.

4. The method of claim 1, wherein the first mathematical relationship has the form of a second-order polynomial relationship:
$${ρ}_{LS} - a * {ρ}_{SS} * {ρ}_{SS} + b * {ρ}_{SS} + c$$
where a, b, and c are coefficients defining basic ribs in the spine-and-rib plot, generating a lookup table using the coefficients, and using the lookup table to determine the formation density.

5. The method of claim 1, wherein the unity area of the spine-and-rib plot is defined by preliminary defined basic data points, and wherein the first mathematical relationship includes coefficients that define basic ribs in the spine-and-rib plot using the preliminary defined basic data points.

6. The method of claim 5, further comprising generating a lookup table containing the coefficients of the first mathematical relationship, and determining the formation density using the lookup table and identifying the coefficients that best fit the obtained first density data (ρ_{SS}) and the second density data (ρ_{LS}).

7. The method of claim 5, wherein determining the formation density using the lookup table includes a mathematical algorithm.

8. The method of claim 1, further comprising using a second mathematical relationship when the measured data point falls outside the unitary area.

9. The method of claim 5, wherein the preliminary defined basic data points include minimum basic data points and maximum basic data points, and the method further comprising:
assuming a target formation density;
a first interpolation using two of the minimum basic data points and the target formation density, providing a first interpolated data point in the spine-and-rib plot;
a second interpolation using two of the maximum basic data points and the target formation density, providing a second interpolated data point in the spine-and-rib plot; and,
wherein the first mathematical relationship performs a fit of the first interpolated data point, the second interpolated data point and the target formation density, and determining the formation density using the assumed formation density.

10. The method of claim 9, further comprising:
determining coefficients of the fitted first mathematical relationship of the first interpolated data point, the second interpolated data point and the target formation density, and using the determined coefficients to determine the formation density.

11. The method of claim 1, wherein the unity area is determined based on one of simulated data, and preliminarily measured data.

12. The method of claim 11, wherein the simulated data is generated using one of a Monte Carlo simulation, a multidimensional solution of the Boltzmann equation, and a neural network.

13. A method for determining a formation density of a downhole formation, the method comprising:
generating tool model data of a downhole tool to be used for measuring density of the downhole formation;
generating requirement data comprising information associated with standoff values, fluid densities, and range of potential formation densities;
using the tool model data and the requirement data, generating a set of responses of a short-spaced detector and a long-spaced detector;
generating a set of basic ribs of a spine-and-rib plot based on the set of responses;
obtaining a first mathematical relationship based on the basic ribs;
defining a unity area of the spine-and-rib plot based on the basic ribs;
generating a lookup table based on coefficients of the first mathematical relationship;
determining the formation density using the lookup table; and,
performing a wellbore operation using the determined formation density.

14. The method of claim 13, further comprising:
measuring a first density ρ_{SS} and a second density ρ_{LS} using the short-spaced detector and the long-spaced detector, respectively;
wherein the determining of the formation density uses the measured first density ρ_{SS} and the measured second density ρ_{LS} based on at least one of the spine-and-rib plot and the lookup table and an interpolation, when the measured first formation density ρ_{SS} and the measured second formation density ρ_{LS} fall within the unity area.

15. The method of claim 14, further comprising:
determining that the measured first density ρ_{SS} and the measured second density ρ_{LS} do not fall within the unity area; and
determining the formation density from a second mathematical relationship using the measured first density ρ_{SS} and the measured second density ρ_{LS}, wherein the second mathematical relationship is different from the first mathematical relationship.

16. The method of claim 14, wherein the first mathematical relationship has the form of a second-order polynomial:
$${ρ}_{LS} = a * {ρ}_{SS} * {ρ}_{SS} + b * {ρ}_{SS} + c$$
where a, b, and c are coefficients of the second-order polynomial.

17. The method of claim 16, further comprising determining the formation density from the lookup table based on the coefficients that best fit the measured first density ρ_{SS} and the measured second density ρ_{LS}.

18. The method of claim 15, wherein the second mathematical relationship has the form of a third-order polynomial:
$${ρ}_{formation} = a + b \cdot {ρ}_{SS} + c \cdot {ρ}_{LS} + d \cdot {ρ}_{SS}^{2} + e \cdot {ρ}_{LS}^{2} + f \cdot {ρ}_{SS} \cdot {ρ}_{LS} + g \cdot {ρ}_{SS}^{3} + h \cdot {ρ}_{LS}^{3} + i \cdot {ρ}_{SS} \cdot {ρ}_{LS}^{2} + j \cdot {ρ}_{SS}^{2} \cdot {ρ}_{LS}$$
where ρ_{formation} is the formation density, and a, b, c, d, e, f, g, h, i, and j are coefficients of the third-order polynomial.

19. The method of claim 13, wherein the wellbore operation is a geosteering operation.

20. The method of claim 14, wherein the formation density is determined within a downhole tool, and the wellbore operation is a drilling operation, wherein the measured first density ρ_{SS} and the measured second density ρ_{LS} are obtained during said drilling operation.
